(19) United States
(12) Patent Application Publication
(10) Pub. No.: US 2007/0061144 A1
(43) Pub. Date: Mar. 15, 2007

(54) Batch statistics process model method and system

(75) Inventors: Anthony J. Grichnik, Peoria, IL (US); Michael Seskin, Cardiff, CA (US); Suresh Jayaram, Naperville, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/213,798

(22) Filed: Aug. 30, 2005

(51) Int. Cl. G10L 15/00

(52) U.S. Cl. 704/256.8

(57) ABSTRACT

A method is provided for process modeling. The method may include obtaining batch statistics data records associated with one or more input variables and one or more output parameters and selecting one or more input parameters from the one or more input variables. The method may also include generating a computational model indicative of interrelationships between the one or more input parameters and the one or more output parameters based on the data records and determining desired respective statistical distributions of the input parameters of the computational model.

### TECHNICAL FIELD

This disclosure relates generally to computer based process modeling techniques and, more particularly, to methods and systems for batch statistics based process models.

### BACKGROUND

Mathematical models, particularly process models, are often built to capture complex interrelationships between input parameters and output parameters. Various techniques, such as neural networks, may be used in such models to establish correlations between input parameters and output parameters. Once the models are established, they may provide predictions of the output parameters based on the input parameters.

Under certain circumstances, explicit values of an input parameter or output parameter may be unavailable or impractical to obtain. For example, in a manufacturing process where hundreds of thousands manufacturing items are produced, it may be impractical to obtain dimensional information for all manufacturing items. When explicit information is not available for the modeling process, the models may not accurately reflect correlations between the input parameters and the output parameter.

Certain process modeling systems, such as disclosed in U.S. Pat. No. 5,727,128 to Morrison on Mar. 10, 1998, develop a set of process model input parameters from values for a number of process input variables and at least one process output variables by performing a regression analysis on the selected set of potential model input variables and model output variables. However, such modeling system may be time and/or computational consuming and may often fail to select input parameters systematically.

Methods and systems consistent with certain features of the disclosed systems are directed to solving one or more of the problems set forth above.

### SUMMARY OF THE INVENTION

One aspect of the present disclosure includes a method for process modeling. The method may include obtaining batch statistics data records associated with one or more input variables and one or more output parameters and selecting one or more input parameters from the one or more input variables. The method may also include generating a computational model indicative of interrelationships between the one or more input parameters and the one or more output parameters based on the data records and determining desired respective statistical distributions of the input parameters of the computational model.

Another aspect of the present disclosure includes a computer system. The computer system may include a database containing batch statistics data records associating one or more input variables and one or more output parameters. The computer system may also include a processor configured to select one or more input parameters from the one or more input variables and to generate a computational model indicative of interrelationships between the one or more input parameters and the one or more output parameters based on the batch statistics data records. The processor may also be configured to determine desired respective statistical distributions of the one or more input parameters of the computational model.

Another aspect of the present disclosure includes a computer-readable medium for use on a computer system configured to perform process modeling procedure. The computer-readable medium may include computer-executable instructions for performing a method. The method may include obtaining batch statistics data records associated with one or more input variables and one or more output parameters and selecting one or more input parameters from the one or more input variables. The method may also include generating a computational model indicative of interrelationships between the one or more input parameters and the one or more output parameters based on the batch statistics data records and determining desired respective statistical distributions of the input parameters of the computational model.

### BRIEF DESCRIPTION OF THE DRAWINGS

FIG. 1 is a block diagram representative of an exemplary process modeling environment consistent with certain disclosed embodiments;

FIG. 2 illustrates a block diagram of a computer system consistent with certain disclosed embodiments; and

FIG. 3 illustrates a flowchart of an exemplary model generation and optimization process performed by a computer system.

### DETAILED DESCRIPTION

Reference will now be made in detail to exemplary embodiments, which are illustrated in the accompanying drawings. Wherever possible, the same reference numbers will be used throughout the drawings to refer to the same or like parts.

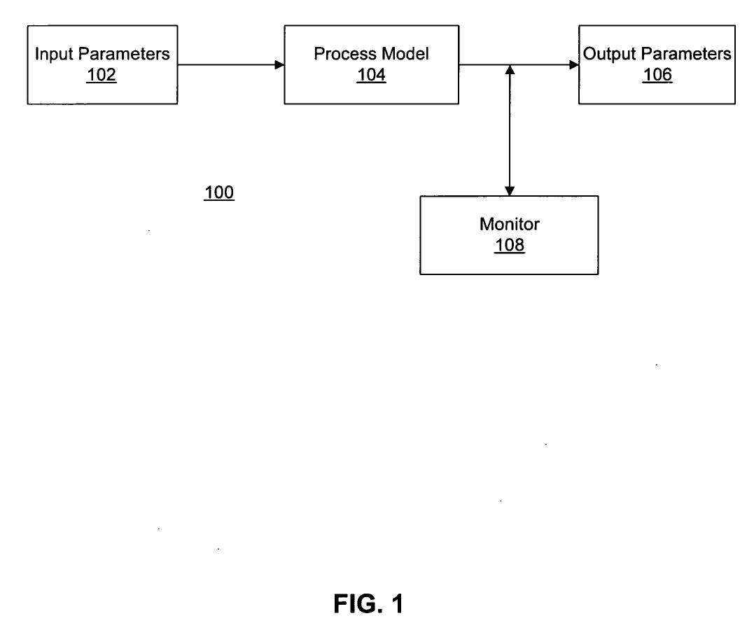

FIG. 1 illustrates an exemplary process modeling and monitoring environment 100. As shown in FIG. 1, input parameters 102 may be provided to a process model 104 to build interrelationships between output parameters 106 and input parameters 102. Process model 104 may then predict values of output parameters 106 based on given values of input parameters 102. Input parameters 102 may include any appropriate type of data associated with a particular application. For example, input parameters 102 may include manufacturing data, data from design processes, financial data, and/or any other application data. Output parameters 106, on the other hand, may correspond to control, process, or any other types of parameters required by the particular application.

Process model 104 may include any appropriate type of mathematical or physical models indicating interrelationships between input parameters 102 and output parameters 106. For example, process model 104 may be a neural network based mathematical model that may be trained to capture interrelationships between input parameters 102 and output parameters 106. Other types of mathematic models, such as fuzzy logic models, linear system models, and/or non-linear system models, etc., may also be used. Process model 104 may be trained and validated using data records collected from the particular application for which process model 104 is generated. That is, process model 104 may be established according to particular rules corresponding to a particular type of model using the data records, and the interrelationships of process model 104 may be verified by using the data records.

Once process model 104 is trained and validated, process model 104 may be operated to produce output parameters 106 when provided with input parameters 102. Performance characteristics of process model 104 may also be analyzed during any or all stages of training, validating, and operating. Optionally, a monitor 108 may be provided to monitor the performance characteristics of process model 104. Monitor 108 may include any type of hardware device, software program, and/or a combination of hardware devices and software programs.

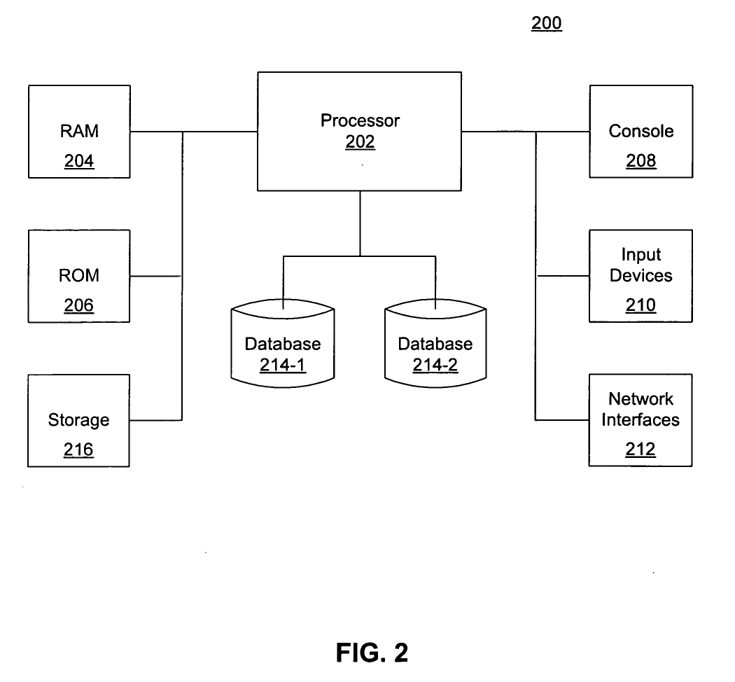

FIG. 2 shows a functional block diagram of an exemplary computer system 200 that may be used to perform these model generation processes. As shown in FIG. 2, computer system 200 may include a processor 202, a random access memory (RAM) 204, a read-only memory (ROM) 206, a console 208, input devices 210, network interfaces 212, databases 214-1 and 214-2, and a storage 216. It is understood that the type and number of listed devices are exemplary only and not intended to be limiting. The number of listed devices may be changed and other devices may be added.

Processor 202 may include any appropriate type of general purpose microprocessor, digital signal processor or microcontroller. Processor 202 may execute sequences of computer program instructions to perform various processes as explained above. The computer program instructions may be loaded into RAM 204 for execution by processor 202 from a read-only memory (ROM), or from storage 216. Storage 216 may include any appropriate type of mass storage provided to store any type of information that processor 202 may need to perform the processes. For example, storage 216 may include one or more hard disk devices, optical disk devices, or other storage devices to provide storage space.

Console 208 may provide a graphic user interface (GUI) to display information to users of computer system 200. Console 208 may include any appropriate type of computer display devices or computer monitors. Input devices 210 may be provided for users to input information into computer system 200. Input devices 210 may include a keyboard, a mouse, or other optical or wireless computer input devices. Further, network interfaces 212 may provide communication connections such that computer system 200 may be accessed remotely through computer networks via various communication protocols, such as transmission control protocol/internet protocol (TCP/IP), hyper text transfer protocol (HTTP), etc.

Databases 214-1 and 214-2 may contain model data and any information related to data records under analysis, such as training and testing data. Databases 214-1 and 214-2 may include any type of commercial or customized databases. Databases 214-1 and 214-2 may also include analysis tools for analyzing the information in the databases. Processor 202 may also use databases 214-1 and 214-2 to determine and store performance characteristics of process model 104.

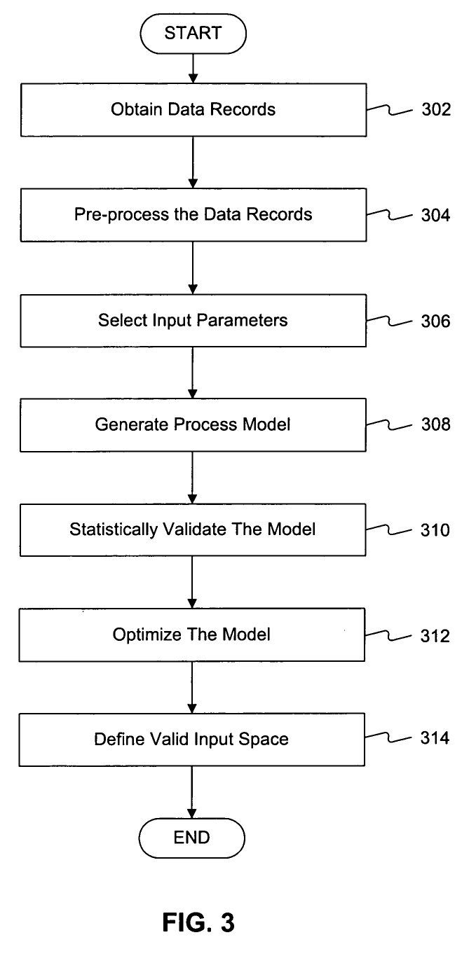

Processor 202 may perform a model generation and optimization process to generate and optimize process model 104. As shown in FIG. 3, at the beginning of the model generation and optimization process, processor 202 may obtain data records associated with input parameters 102 and output parameters 106 (step 302). For example, in an engine design application, the data records may be previously collected during a certain time period from a test engine or from electronic control modules of a plurality of engines. Or, in a manufacturing application, the data records may be collected during or after the manufacturing.

Further, the data records may also be collected from experiments designed for collecting such data. Alternatively, the data records may be generated artificially by other related processes, such as a design process. The data records may also include training data used to build process model 104 and testing data used to test process model 104. In addition, data records may also include simulation data used to observe and optimize process model 104.

The data records may include a plurality of input variables. The input variables may be represented by, mathematically, an input vector
Xᵢ=[x₁, x₂, x₃, . . . , xᵢ],
where x₁₋ᵢ are input process variables or input process dimensions.

The data records may also include a plurality of output variables. And the output variables may be represented by an out vector
Yⱼ=[y₁, y₂, y₃, . . . , yⱼ],
where y₁₋ⱼ are output process variables or output process results.

In certain embodiments, data records may be unavailable for individual items under modeling. That is, a complete individual sampling may be unavailable or impractical. For example, it may be impractical to obtain a dimensional parameter of every manufacturing item when the total number of the items is large. Batch statistics may be used to collect data records including both input parameters 102 and output parameters 106. For example, batch statistics data records may include mean and standard deviation data of input parameters 102 and output parameters 106. Instead of, or in addition to, obtaining values of individual input variables, mean and standard deviation values of the input variables may be obtained. Although mean and standard deviation values of input parameters and output parameters are used as examples, those skilled in the art will recognize that other statistical distribution characteristics may also be used.

A sample size may also be determined to derive or collect mean and standard deviation for a sample group of the sample size. The sample size may be fixed or varied according to types of the applications. For a sample group with a particular sample size, the mean and standard deviation may be collected based on a certain number of members in the sample group. The mean and standard deviation values of the input parameters 102 and output parameters 106 may then be colleted based on the sample groups with respective sample sizes. For example, in an application having a total of 100 items, the sample size may be set at 10 items. For each 10 items, mean and standard deviation may be obtained by sampling 2 or 3 items. Ten data records may be generated.

The batch statistics data records may also be represented by input and output vectors corresponding to the input parameters 102 and output parameters 106. Batch statistics input vector may be represented as
Xᵢ=[ x̅₁, σ₁, x̅₂, σ₂, x̅₃, σ₃, . . . , x̅ᵢ, σᵢ],
where x̅₁₋ᵢ, σ₁₋ᵢ are mean and standard deviations of the input process variables. Also, batch statistics output vector may be represented by
Yⱼ=[ y̅₁, σ₁, y̅₂, σ₂, y̅₃, σ₃, . . . , y̅ⱼ, σⱼ],
where y̅₁₋ⱼ, σ₁₋ⱼ are mean and standard deviations of the output process variables.

After the data records are obtained (step 302), processor 202 may pre-process the data records to clean up the data records for obvious errors and to eliminate redundancies (step 304). Processor 202 may remove approximately identical data records and/or remove data records that are out of a reasonable range in order to be meaningful for model generation and optimization. After the data records have been pre-processed, processor 202 may then select proper input parameters by analyzing the data records (step 306).

The data records may be associated with many input variables. The number of input variables may be greater than the number of input parameters 102 used for process model 104. For example, in the engine design application, data records may be associated with gas pedal indication, gear selection, atmospheric pressure, engine temperature, fuel indication, tracking control indication, and/or other engine parameters; while input parameters 102 of a particular process may only include gas pedal indication, gear selection, atmospheric pressure, and engine temperature.

In certain situations, the number of input variables in the data records may exceed the number of the data records and lead to sparse data scenarios. Some of the extra input variables may be omitted in certain mathematical models. The number of the input variables may need to be reduced to create mathematical models within practical computational time limits.

Processor 202 may select input parameters according to predetermined criteria. For example, processor 202 may choose input parameters by experimentation and/or expert opinions. Alternatively, in certain embodiments, processor 202 may select input parameters based on a mahalanobis distance between a normal data set and an abnormal data set of the data records. The normal data set and abnormal data set may be defined by processor 202 by any proper method. For example, the normal data set may include characteristic data associated with input parameters 102 that produce desired output parameters. On the other hand, the abnormal data set may include any characteristic data that may be out of tolerance or may need to be avoided. The normal data set and abnormal data set may be predefined by processor 202.

Mahalanobis distance refers to a mathematical representation that may be used to measure data profiles based on correlations between parameters in a data set. Mahalanobis distance differs from Euclidean distance in that mahalanobis distance takes into account the correlations of the data set. Mahalanobis distance of a data set Xᵢ (e.g., a multivariate vector) may be represented as
MDᵢ=(xᵢ−μₓ)Σ⁻¹(xᵢ−μₓ)′ (1)
where μₓ is the mean of Xᵢ and Σ⁻¹ is an inverse variance-covariance matrix of Xᵢ. MDᵢ weights the distance of a data point xᵢ from its mean μₓ such that observations that are on the same multivariate normal density contour will have the same distance. Such observations may be used to identify and select correlated parameters from separate data groups having different variances. When batch statistics data records are available, xᵢ may also refer to x̅ᵢ and/or σᵢ. Either x̅ᵢ or σᵢ may be treated in the same way as xᵢ.

Processor 202 may select a desired subset of input parameters such that the mahalanobis distance between the normal data set and the abnormal data set is maximized or optimized. A genetic algorithm may be used by processor 202 to search input parameters 102 for the desired subset with the purpose of maximizing the mahalanobis distance. Processor 202 may select a candidate subset of input parameters 102 based on a predetermined criteria and calculate a mahalanobis distance MDₙₒᵣₘₐₗ of the normal data set and a mahalanobis distance MD_{abnormal} of the abnormal data set. Processor 202 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Processor 202 may select the candidate subset of input variables (e.g., input parameters 102) if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of input variables may be created for further searching. This searching process may continue until the genetic algorithm converges and a desired subset of input variables (e.g., input parameters 102) is selected.

After selecting input parameters 102 (e.g., gas pedal indication, gear selection, atmospheric pressure, and temperature, etc.), processor 202 may generate process model 104 to build interrelationships between input parameters 102 and output parameters 106 (step 308). Process model 104 may correspond to a computational model. As explained above, any appropriate type of neural network may be used to build the computational model. The type of neural network models used may include back propagation, feed forward models, cascaded neural networks, and/or hybrid neural networks, etc. Particular types or structures of the neural network used may depend on particular applications. Other types of models, such as linear system or non-linear system models, etc., may also be used.

The neural network computational model (i.e., process model 104) may be trained by using selected data records. For example, in an engine design application, the neural network computational model may include a relationship between output parameters 106 (e.g., boost control, throttle valve setting, etc.) and input parameters 102 (e.g., gas pedal indication, gear selection, atmospheric pressure, and engine temperature, etc.). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 202 may statistically validate the computational model (step 310). Statistical validation may refer to an analyzing process to compare outputs of the neural network computational model with actual outputs to determine the accuracy of the computational model. Part of the data records may be reserved for use in the validation process. Alternatively, processor 202 may also generate simulation or test data for use in the validation process.

Once trained and validated, process model 104 may be used to predict values of output parameters 106 when provided with values of input parameters 102. For example, in the engine design application, processor 202 may use process model 104 to determine throttle valve setting and boot control based on input values of gas pedal indication, gear selection, atmospheric pressure, engine temperature, etc. Particularly, when batch statistics are used, mean and standard deviation values of output parameters 106 may be directly predicted. Further, processor 202 may optimize process model 104 by determining desired distributions of input parameters 102 based on relationships between input parameters 102 and desired distributions of output parameters 106 (step 312).

Processor 202 may analyze the relationships between desired distributions of input parameters 102 and desired distributions of output parameters 106 based on particular applications. In the above example, if a particular application requires a higher fuel efficiency, processor 202 may use a small range for the throttle valve setting and use a large range for the boost control. Processor 202 may then run a simulation of the computational model to find a desired statistical distribution for an individual input parameter (e.g., gas pedal indication, gear selection, atmospheric pressure, or engine temperature, etc). That is, processor 202 may separately determine a distribution (e.g., mean, standard variation, etc.) of the individual input parameter corresponding to the normal ranges of output parameters 106. Alternatively, processor 202 may directly use mean and standard deviation data when batch statistics are used. Processor 202 may then analyze and combine the desired distributions for all the individual input parameters to determine desired distributions and characteristics for input parameters 102.

Alternatively, processor 202 may identify desired distributions of input parameters 102 simultaneously to maximize the possibility of obtaining desired outcomes. In certain embodiments, processor 202 may simultaneously determine desired distributions of input parameters 102 based on zeta statistic. Zeta statistic may indicate a relationship between input parameters, their value ranges, and desired outcomes. Zeta statistic may be represented as

$$ζ = {\sum }_{1}^{j} {\sum }_{1}^{i} \vert {S}_{ij} \vert ( \frac{{σ}_{i}}{{\overline{I}}_{i}} ) ( \frac{{\overline{O}}_{j}}{{σ}_{j}} ) ,$$

where I̅ᵢ represents the mean or expected value of an ith input; O̅ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, I̅ᵢ may be less than or equal to zero. A value of 3σᵢ may be added to I̅ᵢ to correct such problematic condition. If, however, I̅ᵢ is still equal zero even after adding the value of 3σᵢ, processor 202 may determine that σᵢ may be also zero and that the process model under optimization may be undesired. In certain embodiments, processor 202 may set a minimum threshold for σᵢ to ensure reliability of process models. Under certain other circumstances, σⱼ may be equal to zero. Processor 202 may then determine that the model under optimization may be insufficient to reflect output parameters within a certain range of uncertainty. Processor 202 may assign an indefinite large number to ζ.

Processor 202 may identify a desired distribution of input parameters 102 such that the zeta statistic of the neural network computational model (i.e., process model 104) is maximized or optimized. An appropriate type of genetic algorithm may be used by processor 202 to search the desired distribution of input parameters with the purpose of maximizing the zeta statistic. Processor 202 may select a candidate set of input parameters with predetermined search ranges and run a simulation of the diagnostic model to calculate the zeta statistic parameters based on input parameters 102, output parameters 106, and the neural network computational model. Processor 202 may obtain I̅ᵢ and σᵢ by analyzing the candidate set of input parameters, and obtain O̅ⱼ and σⱼ by analyzing the outcomes of the simulation. In certain embodiments where batch statistics is used, as explained above, each mean or standard deviation of the input and output process variables may be treated as a separate input or outcome during zeta statistic calculation. Alternatively, processor 202 may also directly use x̅ᵢ and σᵢ, and/or y̅ⱼ and σⱼ derived from the neural network computational model. Further, processor 202 may obtain |Sᵢⱼ| from the trained neural network as an indication of the impact of the ith input on the jth outcome.

Processor 202 may select the candidate set of input parameters if the genetic algorithm converges (i.e., the genetic algorithm finds the maximized or optimized zeta statistic of the diagnostic model corresponding to the candidate set of input parameters). If the genetic algorithm does not converge, a different candidate set of input parameters may be created by the genetic algorithm for further searching. This searching process may continue until the genetic algorithm converges and a desired set of input parameters 102 is identified. Processor 202 may further determine desired distributions (e.g., mean and standard deviations) of input parameters based on the desired input parameter set. That is, within a predetermined particular range. Once the desired distributions are determined, processor 202 may define a valid input space that may include any input parameter within the desired distributions (step 314).

In certain embodiments, statistical distributions of certain input parameters may be impossible or impractical to control or change. For example, an input parameter may be associated with a physical attribute of a device that is constant, or the input parameter may be associated with a constant variable within a process model. These input parameters may be used in the zeta statistic calculations to search or identify desired distributions for other input parameters corresponding to constant values and/or statistical distributions of these input parameters.

### INDUSTRIAL APPLICABILITY

The disclosed methods and systems can provide a desired solution for establishing and optimizing modeling process in a wide range of applications, such as engine design, control system design, service process evaluation, financial data modeling, manufacturing process modeling, etc. More specifically, the disclosed methods and systems may be used in applications where complete or 100% sampling is not performed or unavailable.

The disclosed methods and systems may also be used by other process modeling techniques to provide input parameter selection, output parameter selection, and/or model optimization, etc. The methods and systems may be integrated into the other process modeling techniques, or may be used in parallel with the other process modeling techniques.

The disclosed methods and systems may be implemented as computer software packages to be used on various computer platforms to provide various process modeling tools, such as input/output parameter selection, model building, and/or model optimization.

The disclosed methods and systems may also be used together with other software programs, such as a model server and web server, to be used and/or accessed via computer networks.

Other embodiments, features, aspects, and principles of the disclosed exemplary systems will be apparent to those skilled in the art and may be implemented in various environments and systems.

What is claimed is:

1. A method for process modeling, comprising:
obtaining batch statistics data records associated with one or more input variables and one or more output parameters;
selecting one or more input parameters from the one or more input variables;
generating a computational model indicative of interrelationships between the one or more input parameters and the one or more output parameters based on the data records; and
determining desired respective statistical distributions of the input parameters of the computational model.

2. The method according to claim 1, wherein obtaining batch statistics data records includes obtaining mean and standard deviation of the input variables and the output parameters.

3. The method according to claim 1, wherein the input parameters are represented by mean and standard deviation values of a plurality of sample groups with respective sample sizes.

4. The method according to claim 1, wherein the output parameters are represented by mean and standard deviation values of a plurality of sample groups with respective sample sizes.

5. The method according to claim 1, wherein selecting further includes:
pre-processing the batch statistics data records; and
selecting one or more input parameters from the one or more input variables based on a mahalanobis distance between a normal data set and an abnormal data set of the data records.

6. The method according to claim 5, wherein selecting includes:
calculating mahalanobis distances of the normal data set and the abnormal data set based on mean and standard deviation of the subset of variables;
setting up a genetic algorithm; and
identifying a desired subset of the input variables by performing the genetic algorithm based on the mahalanobis distances such that the genetic algorithm converges.

7. The method according to claim 1, wherein generating further includes:
creating a neural network computational model;
training the neural network computational model using the batch statistics data records; and
validating the neural network computation model using the batch statistics data records.

8. The method according to claim 1, wherein determining further includes:
determining a candidate set of input parameters with a maximum zeta statistic using a genetic algorithm; and
determining the desired distributions of the input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{I}}_{i}} ) ( \frac{{\overline{O}}_{j}}{{σ}_{j}} ) ,$$
provided that I̅ᵢ represents a mean of an ith input; O̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

9. A computer system, comprising:
a database containing batch statistics data records associating with one or more input variables and one or more output parameters; and
a processor configured to:
select one or more input parameters from the one or more input variables;
generate a computational model indicative of interrelationships between the one or more input parameters and the one or more output parameters based on the batch statistics data records; and
determine desired respective statistical distributions of the one or more input parameters of the computational model.

10. The method according to claim 9, wherein the batch statistics data records include mean and standard deviation of the input parameters and the output parameters.

11. The method according to claim 9, wherein the input parameters are represented by mean and standard deviation values of a plurality of sample groups with respective sample sizes.

12. The method according to claim 9, wherein the output parameters are represented by mean and standard deviation values of a plurality of sample groups with respective sample sizes.

13. The computer system according to claim 9, wherein, to select one or more the input parameters, the processor is further configured to:
pre-process the batch statistics data records; and
select one or more input parameters from the one or more input variables based on a mahalanobis distance between a normal data set and an abnormal data set of the batch statistics data records.

14. The method according to claim 13, wherein the processor is further configured to:
calculate mahalanobis distances of the normal data set and the abnormal data set based on mean and standard deviation of the subset of variables;
set up a genetic algorithm; and
identify a desired subset of the input variables by performing the genetic algorithm based on the mahalanobis distances such that the genetic algorithm converges.

15. The computer system according to claim 9, wherein, to generate the computational model, the processor is further configured to:
create a neural network computational model;
train the neural network computational model using the batch statistics data records; and
validate the neural network computation model using the batch statistics data records.

16. The method according to claim 9, wherein, to determine desired respective statistical distributions, the processor is further configured to:
determine a candidate set of input parameters with a maximum zeta statistic using a genetic algorithm; and
determine the desired distributions of the input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{I}}_{i}} ) ( \frac{{\overline{O}}_{j}}{{σ}_{j}} ) ,$$
provided that I̅ᵢ represents a mean of an ith input; O̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

17. A computer-readable medium for use on a computer system configured to perform process modeling procedure, the computer-readable medium having computer-executable instructions for performing a method comprising:
obtaining batch statistics data records associated with one or more input variables and one or more output parameters;
selecting one or more input parameters from the one or more input variables;
generating a computational model indicative of interrelationships between the one or more input parameters and the one or more output parameters based on the batch statistics data records; and
determining desired respective statistical distributions of the input parameters of the computational model.

18. The computer-readable medium according to claim 17, wherein the input and output parameters are represented by mean and standard deviation values of a plurality of sample groups with respective sample sizes.

19. The computer-readable medium according to claim 17, wherein selecting further includes:
pre-processing the batch statistics data records to generate a normal data set and an abnormal data set of the batch statistics data records;
calculating mahalanobis distances of the normal data set and the abnormal data set based on mean and standard deviation of the subset of variables;
setting up a genetic algorithm; and
identifying a desired subset of the input variables by performing the genetic algorithm based on the mahalanobis distances such that the genetic algorithm converges.

20. The computer-readable medium according to claim 17, wherein determining further includes:
determining a candidate set of input parameters with a maximum zeta statistic using a genetic algorithm; and
determining the desired distributions of the input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{I}}_{i}} ) ( \frac{{\overline{O}}_{j}}{{σ}_{j}} ) ,$$
provided that I̅ᵢ represents a mean of an ith input; O̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.
